(19) United States
(12) Patent Application Publication
(10) Pub. No.: US 2010/0013859 A1
(43) Pub. Date: Jan. 21, 2010

(54) Enhanced Human Readability of Text Presented on Displays

(75) Inventor: John A. Robertson, Chillicothe, OH (US)

Correspondence Address: MUELLER AND SMITH, LPA;MUELLER-SMITH BUILDING, 7700 RIVERS EDGE DRIVE, COLUMBUS, OH, 43235, US

(73) Assignee: SIMPATEXT, LLC, Chillicothe, OH (US)

(21) Appl. No.: 12/499,162

(22) Filed: Jul. 8, 2009

Related U.S. Application Data
(60) Provisional application No. 61/080,765, filed on Jul. 15, 2008.

(51) Int. Cl. G09G 5/00

(52) U.S. Cl. 345/646

(57) ABSTRACT

Disclosed is the presentation of text data on a high-resolution display screen using an image, which includes nonlinear (3D) surface undulation and viewing perspective. This presentation results in variations of character size, rotation, and aspect across the screen. Additionally, positional cues, and coloration gradations may be added. As will be shown, all of this assists human readability and reduces fatigue.

### CROSS-REFERENCE TO RELATED APPLICATIONS

This application claims benefit of provisional application Ser. No. 61/080,765, filed on Jul. 15, 2008, the disclosure of which is expressly incorporated herein be reference.

### STATEMENT REGARDING FEDERALLY SPONSORED RESEARCH

Not applicable.

### BACKGROUND

The present invention generally relates to methods of enhancing the readability of text when it is presented on a display. It is commonly accepted that people, given the choice, would prefer to read textual material, which is printed rather than view the same characters presented on a display herein called a “screen”. A great deal of research has been done on so called “Human Factors” to determine, for example, the optimal font, character size, and line length for a screen display¹²³. Unfortunately, the problem remains; people heretofore have not preferred to view text on a screen. This disclosure will teach methods to enhance the readability of text on a screen. ¹ See for example Visual Communication for Forms Design published by the Ohio Department of Administrative Services, General Services Division STATE FORMS MANAGEMENT Columbus Ohio 614-466-0856² See for example Reading Text from Computer Screens by Carol Bergfeld Mills and Linda Weldon CAN Computing Survets Vol 19, No. 4 December 1987³ See the Psychology of Reading by Keith Rayner and Alexander Pollasek, Lawrence Eribaum Associates, Publishers Hillsdale, N.J.

### BRIEF SUMMARY

It is this inventor's opinion that the reason for the preference of paper over screen display results due to several shortcomings in the screen presentation. These shortcomings include, inter alia:
(i) The contrast between the characters and the background normally is very high; pleasing subtlety is missing.
(ii) The eye and brain typically are lost in a “sea” of identical font, identically sized, high contrast characters as rectilinear lines. The reader must use a great deal of effort to maintain attention as to just where he or she is on the page.
(iii) There are no reference features to help reposition the eye without getting lost. This makes avoidance of the eye's imperfections, blinking of the eye, sequential saccades⁴, accommodating spasms (older people), repeatedly moving focus to the resting point of accommodation (RPA)⁵ or dealing with an eye's astigmatism most difficult. ⁴ In reading the eye jumps in motions called saccades and pauses in periods called fixation⁵ This is a major cause of Computer Vision Syndrome (CVS).
(iv) There is nothing to relieve the boredom of the high contrast, uniform, rectilinear display. Reading a book presented on a screen becomes a slog.

Recent advances in display screen technology provide higher resolution, color and improved contrast control (gray level). With proper presentation, such screens can advantageously be used to improve readability. Additionally, advances in electronics now permit a computationally intensive modification (simulation) of the screen presentation directed toward the improvement of human readability. We no longer need to consider screens to be simply terminal-like character displays.

Disclosed is the presentation of text data on a high-resolution display screen using an image, which includes nonlinear (3D) surface undulation and viewing perspective. This presentation results in variations of character size, rotation, and aspect across the screen. Additionally, positional cues, and coloration gradations may be added. As will be shown, all of this assists human readability and reduces fatigue.

### BRIEF DESCRIPTION OF THE DRAWINGS

For a fuller understanding of the nature and advantages of the present invention, reference should be had to the following detailed description taken in connection with the accompanying drawings, in which:

FIG. 1 is a reference screen display as is typical of a page displayed on a prior art screen. This is the “conventional screen”;

FIG. 2 depicts the text contained in the conventional screen as photographed from a curved spine book at near normal reading angle;

FIG. 3 depicts the conventional screen as photographed at an inclined angle and on a colored undulating surface;

FIG. 4 depicts a section of the conventional screen photographed using a simulated spine, which produces locally both upward and downward curved lines;

FIG. 5 Is a block diagram of a possible configuration of a system which accepts document text data files, a selected topographic data file, a background markings and coloration file, and a font file and produces the proposed readability enhanced presentation on the inventive display screen;

FIG. 6 presents for introduction and explanation, two side-by-side display screens, where FIG. 6A depicts a conventional rectilinear screen and FIG. 6B shows the rectilinear grid of 6A as it appears on a inventive, undulating surface viewed at a perspective angle; and

FIG. 7 presents one possible flow chart for the proposed method of mapping text onto the inventive screen page.

The drawings will be described in further detail below.

### DETAILED DESCRIPTION

### Introduction to the Goals and Advantages

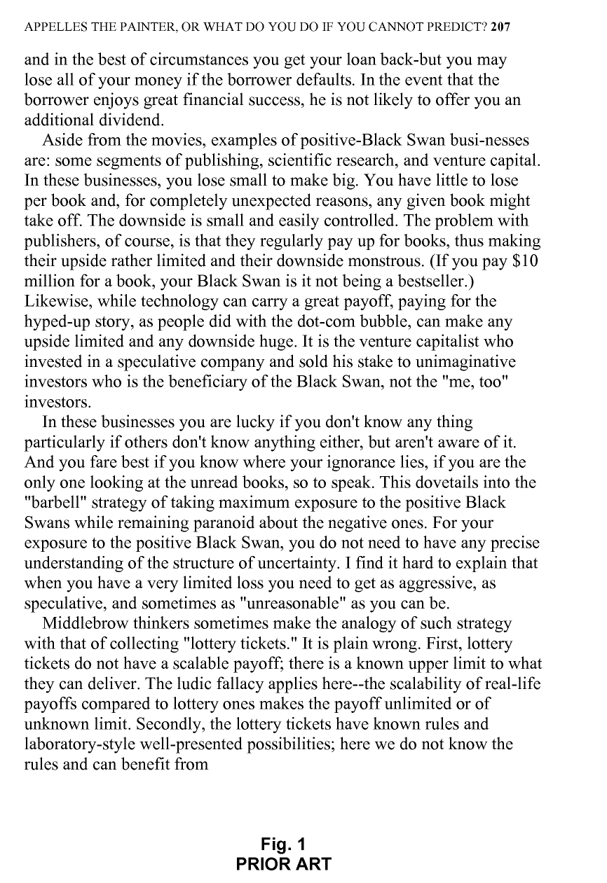

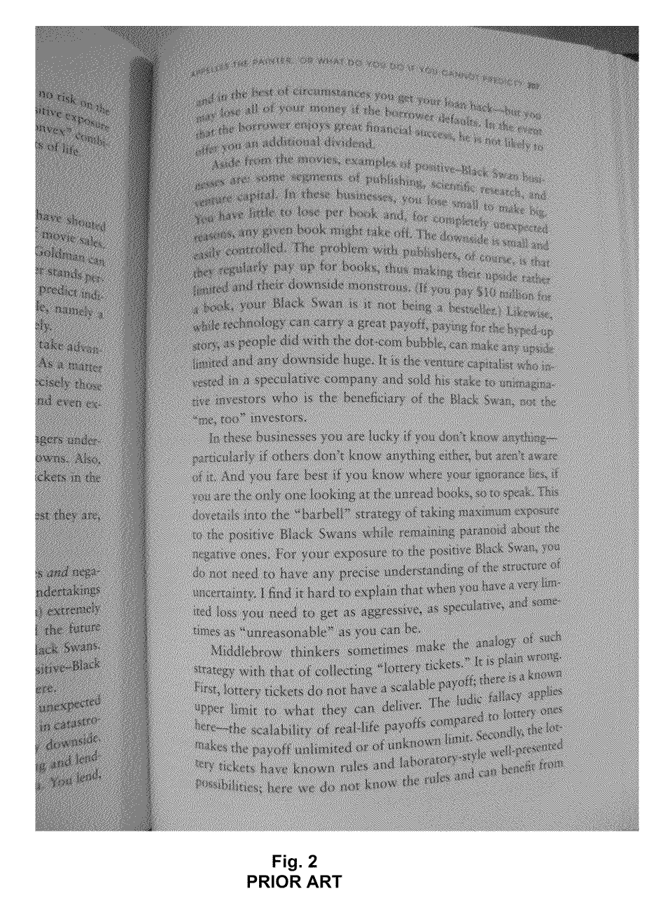

We usually read text on a screen, which is conventionally presented to us as rectilinear lines of black characters on a white background. FIG. 1 presents how such a conventional display appears. When we see the same text in a book, FIG. 2, somehow it appears more pleasing and easier to read especially when viewed on a diffuse, possibly colored page. I have long asked why.

The book or printed page by its nature presents the printed text on an, undulating surface (possibly due to a fold) which when observed at a perspective angle from the bottom edge, also makes the characters at the top of the page appear smaller than those closer to the reader's eyes. Additionally, the print contrast (especially in poor lighting) is not as severe as is the screen contrast in the conventional display. The reflected (typically white) background also contains subtle gradations indicative of the angle of illumination. The undulations, perspective, and lighting may subtly vary as we read.

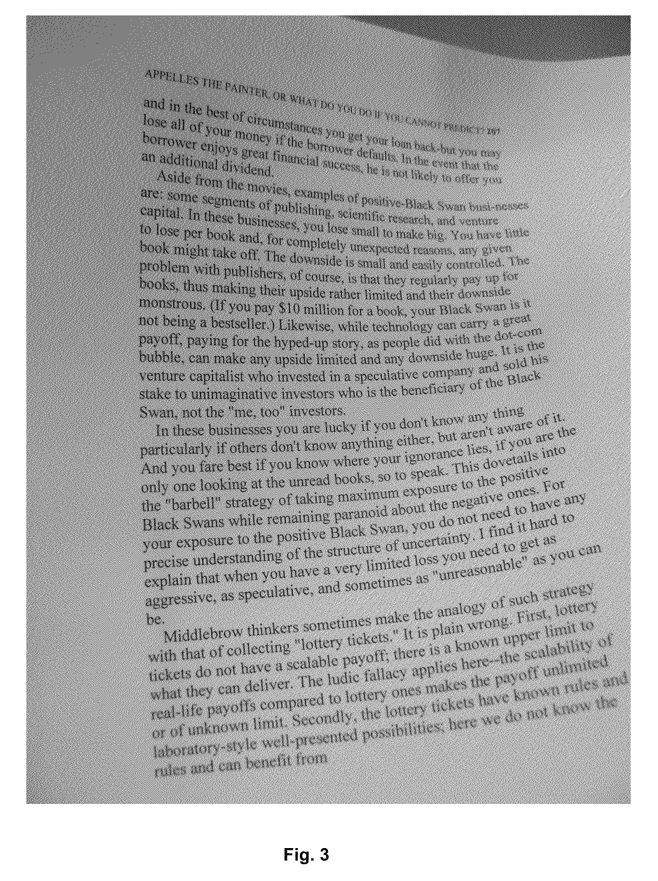

If the above features of a book or printout are exaggerated, we obtain a picture as in FIG. 3. Here, the undulation is more wavelike and the viewing is from a lower angle than a reader would commonly use. Although this exaggerated presentation at first appears as though it would confuse reading, it does not. If we read a bit of FIG. 1 and then the same section in FIG. 3, many people find the exaggerated presentation of FIG. 3 easier to read.

When reading long sections of text, it would be comfortable to periodically break up the session by using differing presentation perspective, coloration, and undulation. One should be able to easily vary the presentation perspective, coloration and undulation as one can now alter page size and font.

To gain insight as to why the exaggerated presentation of FIG. 3 is easier to read, one might try a test: Looking at FIG. 1 (conventional screen presentation), focus on a word in the middle of a block of text, glance away for a few seconds and then look back to re-find the word. Compare this to the same test in the exaggerated presentation of FIG. 3. Most people find it much quicker to re-find the character in the exaggerated presentation. Humans appear to have evolved with sensitivity to finding items where they remember them within a featured environment; the perspective, size, and other landscape variations make it easier to read because one remembers or senses where they are in the landscape. We then need not sequence tirelessly word pairings to word parings so that we do not lose our current attentive position.

A program was written to test the aforementioned “easier to re-find” proposition. The test subject was first shown a highlighted word in the conventional rectilinear text presentation (FIG. 1) and was asked to hit a button each time the same word (not highlighted) was rediscovered after the presentation was randomly repositioned in both X and Y. Each word was relocated 5 times and then another word was selected for 5 more relocations. After 6 different words, the test subject was shown the same text presented in a perspective and undulating fashion with a colored and varying intensity background (FIG. 2). The subject again was asked to press a button when the highlighted word was found (not highlighted) after random X and Y relocation of the page.

The above mentioned test was given to 20 test subjects with half of the subjects seeing the conventional rectilinear presentation first and half of the subjects seeing the perspective and undulating presentation first. The results of this test qualitatively indicate that readers refind words about 15% to 20% faster in the perspective and undulating presentation.

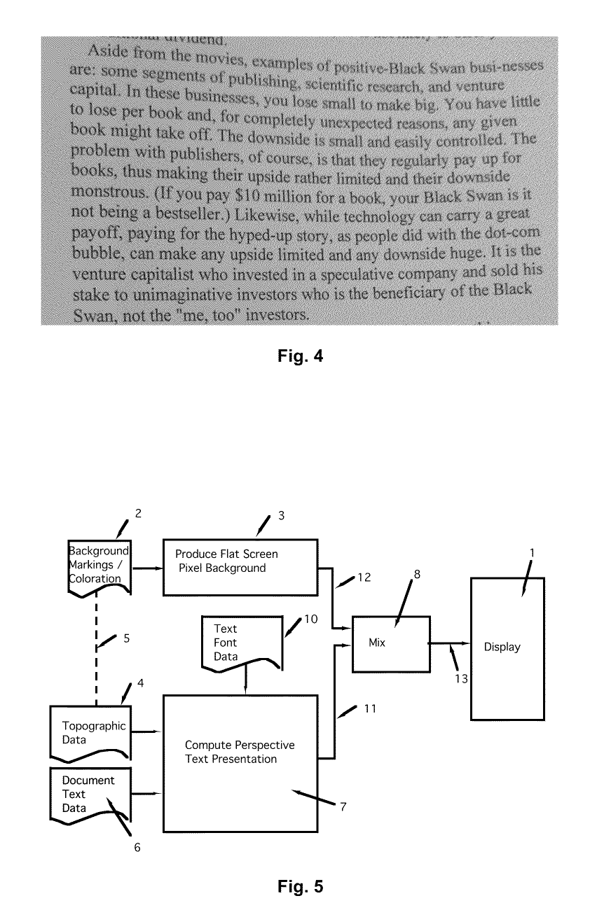

The idea of using curved text lines was suggested by Bizziocchi in U.S. patent application Ser. No. 10/096,746 (U.S. Publication No. 2003/0215775, now abandoned). Bizziocchi suggested that properly curved lines (downward from the line start) were of value in helping one's eyes linefeed between lines; the eye can reset from the end of a downward curved line straight across back to the beginning of the subsequent line. In FIG. 4, we present a portion of the same text photographed to show downward curvature at the line ends. This inventor posits that the curvature of FIG. 4 is not as readable as is the text of FIG. 3, which is provided with undulation and perspective. The sea of downward curving identical characters of FIG. 4 without other clues in the landscape is not as easy to read as is FIG. 3. In fact the FIG. 3 exaggerated presentation suggests that even an uphill curvature, can be advantageous within a presentation, which provides perspective and an undulating, featured landscape.

There have been people attempting to simulate real books using 3D graphics. This is the basis of the Turning-the-Pages site of the British Library. These presentations are directed to maintaining the original book quality rather than to improve readability.⁶ ⁶ See http://www/bl.uk/onlinegallery/ttp/ttpbooks.html

Morsello in U.S. Pat. No. 7,028,260 suggests methods for placing and rotating characters and related characters at a path corner to make the indicia more pleasing. We envision no (abrupt) corners in our renderings for readability.

It is also interesting to note that at least one group has discussed progress in producing realistic looking books and then suggests that few people will want to read them in that format!⁷ ⁷ Realistic books: A bizarre homage to an obsolete medium? Yi-Chun Chu, David Bainbridge, Matt Jones and Ian H. Witten Department of Computer Science University of Waikato Hamilton, New Zealand {ycc1, davidb, mattj, ihw}@cs.waikato.ac.nz

Fushiki in U.S. Pat. No. 6,803,913 describes a system and method for manipulating text relative to a curved reference line in order to transform a character, rendered in a particular font, to generate a warped character with the degree of warping reflecting the local curvature of the curved reference line. The curvature of the reference line is reflected in the nature of quadrilaterals, i.e., quads, generated for a corresponding rectangle on a straight reference line. The coordinates of the corners of the quad provide the parameters to carry out the transformation. Such rendering improves the appearance of the text and provides a method that modifies available fonts in a flexible fashion without the need to generate new fonts. We do not propose to render characters using the computationally intensive Fushiki method primarily, because in our proposed method of enhancing document readability (to follow), will typically render a page of text containing many (relatively small) characters which each locally will require only rotation and aspect ratio alteration to produce acceptable text appearance.

Charles Petzold has described rendering text on a generalized path with WPF but does not suggest that text on a curved path improves readability.⁸ ⁸ MSDN Forum July 2009. See http://msdn.microsoft.com/en-us/magazine/dd263097.aspx

Walker in U.S. Pat. No. 7,036,075 proposes enhancement to bring attention to rule defined content of the original author's text. He suggests attention enhancement by presenting text with curved lines having content variable “dangle points”, as well as other methods such as coloration, spacing, and indentation. Walker does comment:
The curves enhance the “visual prosody” of the text presentation. Each sentence acquires an even more unique visual appearance. The curves also break up the monotony of linear presented text, which may reduce fatigue of the eye muscles.
Walker at col. 34 II, I. 66 bridging col. 35, I. 3.
   Walker does not suggest the use of curved text to enhance the reading of the entire text absent selection rules.

Another use of curved text to gain attention and highlight relationships is shown in Chang in U.S. Pat. No. 7,188,306, entitled, “Swoopy Text For Connecting Annotations In Fluid Documents”. Chang uses a “swoop” of text to connect primary source data with secondary data. Again the use of this swoop is to highlight information (using a weighted “user focus tag”) not to enhance the overall document readability.

A computer application called Bix Photobook (Outerspace Software, Amsterdam the Netherlands), a 3D photo browser, presents selected photos (images) on turnable pages and displays the reduced sized pictures as if they were on a splined page viewed as if in perspective. The photos, when enlarged, are viewed as rectilinear presentations and there is no indication that this application aids in the readability of text or that it converts text files into viewable images.

An article, “Creating and Reading Realistic Electronic Books” ⁹ describes the creation of pleasing electronic representations of books, the enabling of turning their pages, and the learning enhancement when compared to ordinary HTML or PDF pages. Some of the pages or their electronic representations contained images (pictures) and the authors comment that these images appeared to provide useful landmarks to the readers. No mention is made of having the HTML or PDF pages or the book representations provide either undulation, perspective, background contrast or color gradients. ⁹ Creating and Reading Realistic Electronic Books Liesaputra, V.; Witten, I. H.; Bainbridge, D.; Computer Volume 42, Issue 2, February 2009 Page(s):72-81

The Computational Creation of a Visually Enhanced Text Display—Method 1

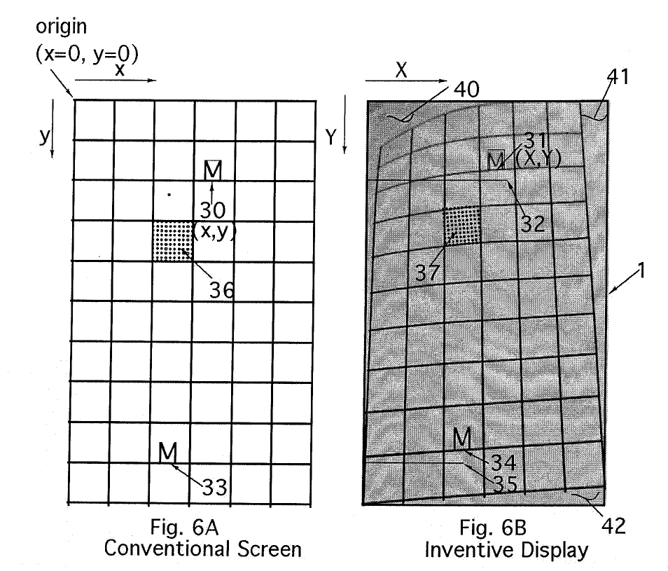

Referring to FIG. 5, our goal is to produce a display on screen 1 of text from the source; Document Text Data 6. The Document Text Data 6 is, for example, ASCII text from a document page (possibly previously OCR scanned).

Our goal is to produce a display on screen 1 which contains positional cues and pleasing contrast and coloration to facilitate human reading without the fatigue resulting if Document Text Data 6 were simply displayed as conventional high contrast (commonly black on white) rectilinear lines of characters similar to those presented by FIG. 1. Our goal-enhanced display might, for example, appear much like that shown in FIG. 3 albeit probably less exaggerated.

In order to provide a pleasing “apparent topology” for the goal display, we start with a set of topographic data 4 (details to follow). In overview, this topographic data 4 presents a (pre-computed) look up table, which permits the relocation of characters from the rectilinear coordinates of the conventional presentation to where they would appear on a specific undulating surface, if viewed from a particular elevation and distance. In addition to simple relocation on the inventive screen map, the topographic data also provides information on how the characters at that relocated point should be scaled (horizontally and vertically) and rotated as necessary to depict them, as they would appear on the instance undulating surface from a fixed observation distance and elevation. The topographic data 4 may apply to one or more pages of inventive screen display and can be periodically changed to maintain reading interest. It is also possible that the undulation curvature might be changed between alternating pages, much as a book spine would.

Data 2 provides a frame of how the background markings and coloration of the goal inventive display should appear for the instance page. Data 2 might include color highlights, as if the inventive display were illuminated from some angle, and also might include reference marking (for example a “watermark”). Both coloration and reference markings would (in most cases) not be rectilinear, as they would necessarily, for best appearance, follow or result from the undulations of the topology. Dotted connection 5 is included to connote the fact that the two instance databases 2 and 4 may be related. The background also may include border features including even a sense of how many pages have been turned.

Module 3 produces the pixels for the background of the goal display, while module 7 computes the pixels for the characters as they are repositioned, sized, and rotated. The outputs of module 3 at line 12 and module 7 at line 11 then are mixed by module 8 to provide the final pixel stream at line 13 for display by inventive display screen 1.

The majority of the rendering computation occurs in module 7, which accepts (i) the Document Text Data for the instance page from file 6, (ii) the Text Font Data for the instance page from file 10, and (iii) the Topographic Data for the instance page from file 4 and proceeds to create an inclined perspective image which includes the perception of topology undulations, perspective and background highlights on line 11.

Module 7 might accomplish the desired character repositioning, character aspect correction, and character rotation, in many ways and by various orderings of the steps. For example, free form topographic reshaping is used widely in the animation industry, where specialized computational hardware may be employed and the time delay required to create a new movie) frame is acceptable.

### Here We Will Detail Only Two Possible Methods.

First we will present a computational process, which is practical for implementation in an inexpensive consumer machine (PC), because it provides one or more sets of topographic data 4 in the form of compact look up table(s) and further reduces computational overhead by accepting certain first order approximations. This enables the rapid placing, sizing, and rotating of text characters, so that they appear on the screen as if they are on a simulated topology-our goal.

### Method 1—The Computational Process Using Look Up Arrays

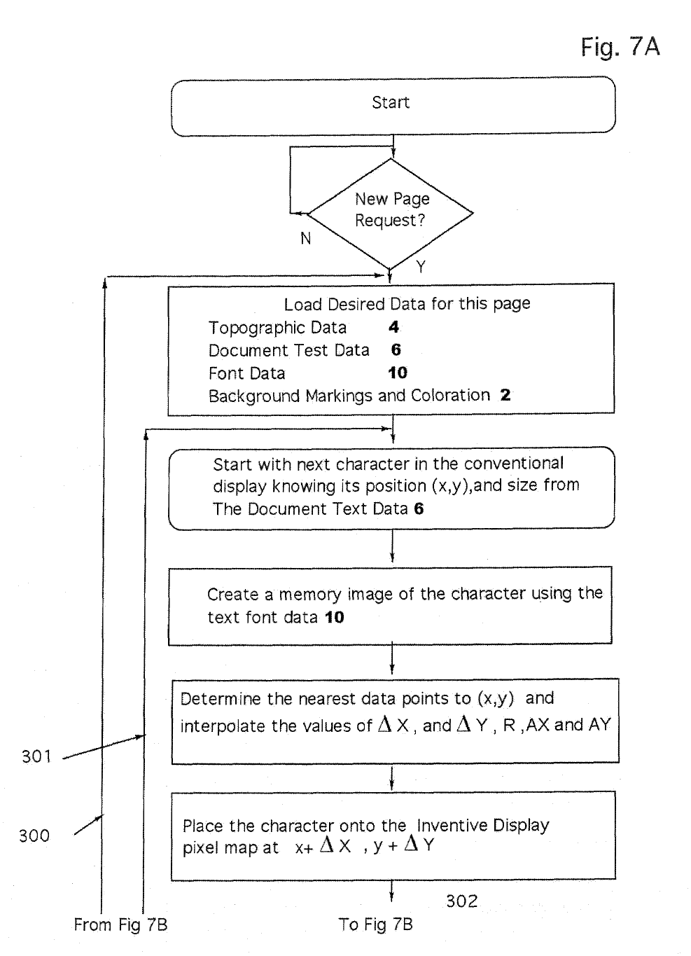

Referring now to FIG. 6, in FIG. 6A we depict the conventional (portrait oriented) screen with rectilinear grid rulings, as if it is flat and viewed head on. Two identical “M” characters lie on the flat screen at positions 30 and 33. These characters are shown to be larger than typical text on the flat screen to clarify the process description. Position 30 for example denotes the bottom center of a rectilinear character, as it would be placed in a conventional (prior art) text screen. We will identify screen positions on FIG. 6A by (x,y) with the origin and positive directions as shown. In FIG. 6B, the physical coordinates are X and Y with the origin and directions shown for the inventive display.

FIG. 6B (the inventive display screen) depicts the same grid rulings of FIG. 6A, but as they would appear if the rectilinear conventional screen had been viewed at an angle from the screen bottom and the rectilinear screen surface topology had been distorted by undulation. The specific topology undulation height and shape is not critical. The topology would be chosen based on tradeoffs between creating an interesting landscape to improve text readability without losing too much of the useable screen areas at areas such as 40, 41, and 42.

Our goal is to map conventional rectilinear placed characters 30 and 33 to those at 31 and 34 on the inventive screen. We will first focus on the character at position 30, which maps to location 31 on the inventive screen. Position 32 is the same physical display location as position 30. Thus, the character bottom center 30 needs to be moved from 32 to 31 on the inventive presentation. As would be expected, we also may need to (i) scale the character's height and width to provide the desired subtle features (characters at the top of the page are smaller even on locally flat areas of undulation). The local undulation [slope and direction] can affect both the height and width), and (ii) rotate the height and width adjusted character when placed at 31.

To accomplish this method, I propose that a relatively low-resolution array of points be envisioned on the entire conventional rectilinear display (see FIG. 6A) is provided for each (of potentially many) topology. Each of the selected points, for example in representative region 36 would index related topology data (to be described) and appear as representative region 37 in the inventive display 1. The totality of the array points and their related data for a selected topology would be passed to the system, as topographic data 4. Screen 6A might for example utilize a 400 (V)×225 (H) matrix (this is an HDTV aspect ratio screen rotated 90 degrees). Data associated with each of the 400×225=90,000 array points would be pre-computed for the instance viewing point (eye elevation and distance from the page bottom edge) and instance surface undulation. The mapping process will be illustrated here for just one viewing point and surface undulation, but it should be understood that a different topology data set could be used for each point array. It is even possible to reposition the array points to provide interesting subtle changes upon the inventive display.

Each selected array point at position x,y in FIG. 6A would include at least the following:

D(x,y)=ΔX, ΔY, AX, AY, R

where:
D(x,y) is the data set associated with the array point at (x,y);
Δ X is the translation in X when moving from (x,y) in the conventional display to (X,Y) in the inventive display. For example the X change between 32 to 31 specifically for an array data point, which exists at point 30;
Δ Y is the translation in Y when moving from (x,y) in the conventional display to (X,Y) in the inventive display. For example the Y change between 32 to 31 specifically for an array data point, which exists at point 30;
AX is the aspect change in character width for a character placed at (X,Y);
AY is the aspect change in character height for a character placed at (X,Y); and
R is the rotation at (X,Y) for a character placed there from (x,y).

The above data could be floating point numbers (with sign) but the quantity of data might be reduced, if certain simplifying assumptions are made;
(i) The Δ X and Δ Y directions and magnitudes could be described by two bytes each; thus, giving ±1 part in 32768 resolution which would provide much less than 1 pixel resolution in currently envisioned display technology.
(ii) The character aspect corrections AX (Width) and AY (height) could each be 1 byte; thereby, providing ±128 steps in height or width.
(iii) The original character (font and size) can be rotated using R about (X,Y) without making second order (trapezoid) corrections. This is likely to produce an acceptable inventive presentation, because the characters are generally quite small and thus trapezoidal corrections would be difficult for the eye to perceive. If R is, for example, one byte of data, it could represent −64 to +64 degrees of rotation with ½ degree resolution.

This particular approach would require only 7 bytes of data for each (x,y) array point or 630 Kbytes for our entire example 400 by 225 array topology file 4; a practical file size. We will, of course, need to determine D(x,y) for points which are not in the point array positions. This can be done by linear interpolation using the nearest neighbor array points. Because the surface and local changes in aspect and rotation are relatively “smooth”, a linear interpolation should be suitable. The initial creation of D(x,y) at the array points and various appropriate methods of interpolation will be apparent to those skilled in the art of 3D surface manipulation.

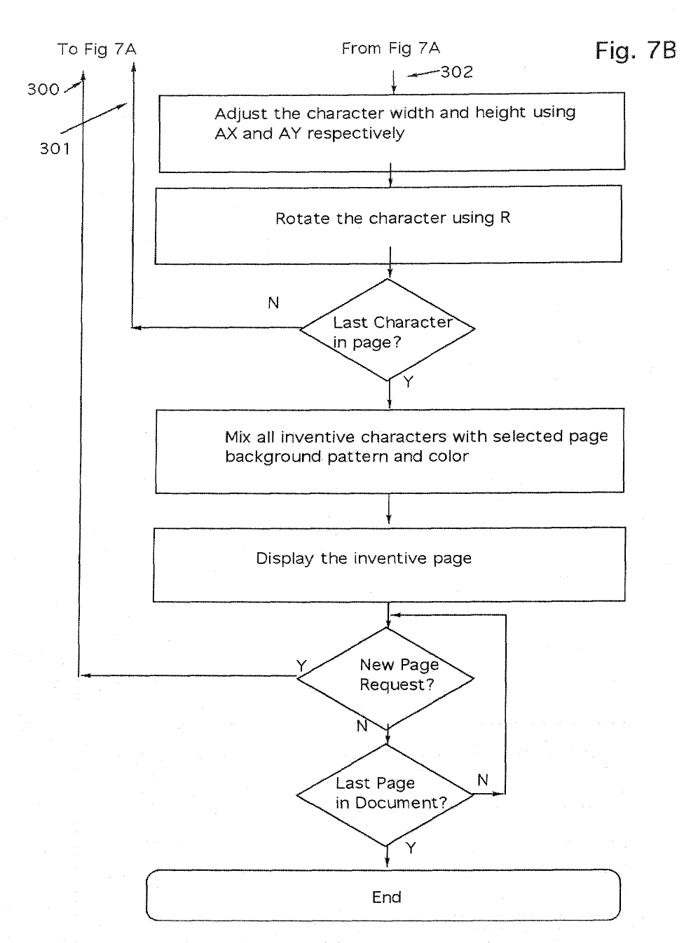

The flow chart depicting the method of moving a character from the conventional screen to a position on the inventive display is shown in FIG. 7.

Next we will introduce a software intensive method. Although currently not as fast as method 1, it will become more practical as computer capabilities grow.

Method 2—The Software Intensive Computational Creation of a Visually Enhanced Text Display

A printed page of text is commonly viewed at an angle, and might also be curved somewhat. The algorithm described below is intended to simulate perspective and curvature of a page of text on the computer screen, but in a way that is computationally efficient, requires a minimum of parameters, and maintains fidelity of the text.

The algorithm avoids the use of 3D graphics, which can be time-consuming, not available on some platforms, and might actually degrade text readability. It, instead, requires only a graphics programming environment that allows each character on a page to be independently manipulable with standard two-dimensional affine transforms-translation to another position, scaling in size in either the horizontal and vertical dimensions, and rotation. Individual characters are not tapered.

A page of text has a width of W and height of H. These can be metrical units (based on inches or millimeters, for example), or pixels, or arbitrary units. Any location on the page can be represented by the point (X, Y), where X is between 0 and W, and Y is between 0 and H.

It is assumed here that values of X increase from left to right, and values of Y increase from top to bottom, although these conventions are not necessary. With these conventions, the upper-left corner of the page is the point (0, 0), the upper-right corner is (W, 0), the lower-left is (0, H), and the lower right is (W, H).

The objective here is to derive a process that can convert any point (X, Y) on the original page to a point (X′, Y′) on the transformed page. The X′ value will not necessarily be between 0 and W, and Y′ will not necessarily be between 0 and H.

The simulated perspective and curvature of the page is governed by two curves, one associated with the top of the page and the other associated with the bottom of the page. These can be any type of curve defined by parametric formulas, but will likely be some kind of two-dimensional Bezier curve, since these are well supported in computer graphics environments.

Solely for purposes of illustration, quadratic Bezier curves will be used here. A quadratic Bezier curve is defined by three points: the curve begins at the point (X_{beg}, Y_{beg}), and ends at (X_{end}, Y_{end}). Between those two points, the curve bends toward (but does not necessarily pass through) a control point, (X_{ctrl}, Y_{ctrl}).

The parametric formulas that describe the quadratic Bezier Curve are:

X(t)=(1−t)²×X_{beg}+2t(1−t)×X_{ctrl}+t²×X_{end}

Y(t)=(1−t)²×Y_{beg}+2t(1−t)×Y_{ctrl}+t²×Y_{end}

for t from 0 to 1. (Notice that for t equals zero, X and Y equal X_{beg} and Y_{beg}, respectively, and for t equals 1, X and Y equal X_{end} and Y_{end}, respectively.)

One curve, Qₜₒₚ, is associated with the top of the page, and another, Q_{bot}, is associated with the bottom of the page. Thus, with the use of quadratic Bezier curves, the entire perspective and curvature of the page is controlled by a mere six points.

For Qₜₒₚ, (X_{beg}, Y_{beg}) will usually be in the vicinity of the upper-left corner of the untransformed page, that is, the point (0, 0), and (X_{end}, Y_{end}) be in the vicinity of the point (W, 0). Similarly, for Q_{bot}, (X_{beg}, Y_{beg}) will usually be in the vicinity of the lower-left corner of the page, the point (0, H), and (X_{end}, Y_{end}) be in the vicinity of the point (W, H).

If the two curves begin and end at the untransformed corners of the page, and if the Qₜₒₚ control point is (W/2, 0) and the Q_{bot} control point is (W/2, H), the transformed page is the same as the untransformed page.

Otherwise, the transformed page has an overall shape that is curved at the top and bottom. The top of the transformed page is given by the curve Qₜₒₚ and the bottom by Q_{bot}. The left side of the transformed page is a straight line between the begin points of Qₜₒₚ and Q_{bot}. The right side is a straight line between the end points of Qₜₒₚ and Q_{bot}.

For any point (X, Y) on the page, an interpolated curve between Qₜₒₚ and Q_{bot} can be found based on the Y coordinate relative to the height of the page. Then, a point (X′, Y′) on that interpolated curve can be found using the parametric equations of the interpolated curve based on the X coordinate relative to the width of the page.

The interpolation is performed with this process: The curve Qₜₒₚ has a length Lₜₒₚ, and Q_{bot} has a length L_{bot}. These lengths may be calculated simply by applying the Pythagorean Theorem to the begin and end points, or in a more complex manner by calculating the actual geometric lengths of the curves. These relative lengths will govern the perspective effect. Calculate a ratio of the bottom length to the top length:

R=L_{bot}/Lₜₒₚ

For any point (X, Y) on the page, calculate a vertical position of the point relative to the height of the page:

tᵥₑᵣₜ=Y/H

Obviously, tᵥₑᵣₜ will range from 0 to 1. Adjust this value for a perspective effect using the R value calculated above:

tₚₑᵣₛ=(2×tᵥₑᵣₜ+(R−1)×tᵥₑᵣₜ²)/(R+1)

This formula is based on the integral of a straight-line interpolation. If R equals 1, tₚₑᵣₛ always equals tᵥₑᵣₜ. Otherwise, when tᵥₑᵣₜ equals 0 (which corresponds to the top of the page), tₚₑᵣₛ will also equal 0. When tᵥₑᵣₜ equals 1 (the bottom of the page), tₚₑᵣₛ will also equal 1, but if R equals 2 (that is, Q_{bot} is twice the length of Qₜₒₚ), then when tᵥₑᵣₜ equals 0.5, tₚₑᵣₛ will equal approximately 0.42, closer to the top than the bottom.

Use tₚₑᵣₛ to interpolate between the points that define Qₜₒₚ and the points that define Q_{bot} to derive the points that define the interpolated curve Qᵢₙₜₑᵣ.

Using this interpolated curve, a point can be found on that curve using the following process:

Calculate a relative horizontal position of the point on the page:

t_{horz}=X/W.

This value t_{horz} will also range from 0 to 1. Use this value in the parametric formulas for Qᵢₙₜₑᵣ to find (X′, Y′).

Now that it is known how to transform any point (X, Y) to (X′, Y′), this process can be applied to three corners of each text character as described here:

The upper-left corner of each character of text on the page is located at the point (X_{left}, Yₜₒₚ) relative to the upper-left corner of the page. (On many pages of text, Yₜₒₚ will be the same for all characters in the same line of text, and X_{left} will be the same for the first characters of each line of text, but these assumptions are not required.)

Each character has a width W_{ch} and a height H_{Ch}. (This height is the same for all characters of a particular font and font size.) The upper-right corner of each character is therefore (X_{left}+W_{ch}, Yₜₒₚ) or (X_{right}, Yₜₒₚ). The lower-left corner of the text character is the point (X_{left}, Yₜₒₚ+H_{ch}) or (X_{left}, Y_{bottom}).

Use Yₜₒₚ to find an interpolated curve corresponding to the top of the character. Use that curve with a t value based on X_{left} to transform (X_{left}, Yₜₒₚ) to (X′_{left}, Y′ₜₒₚ). Use that same curve with a t value based on X_{right} to transform (X_{right}, Yₜₒₚ) to (X′_{right}, Y′ₜₒₚ).

Use Y_{bot} to find an interpolated curve corresponding to the bottom of the character. Use that curve with a t value based on X_{left} to transform (x_{left}, Y_{bot}) to (X′_{left}, Y′_{bot}).

It is then possible to derive a standard graphical transform for that character based on the composite of the following transforms performed in this order:

Horizontal scaling calculated as (X′_{right}−X′_{left})/(X_{right}−X_{left})

Vertical scaling calculated as (Y′_{bottom}−Y′ₜₒₚ)/(Y_{bottom}−Yₜₒₚ)

Rotation based on the angle of the line from (X′_{left}, Y′ₜₒₚ) to (X′_{right}, Y′ₜₒₚ)

Horizontal translation calculated as (X′_{left}−X_{left})

Vertical translation calculated as (Y′ₜₒₚ−Yₜₒₚ).

Each character of text is scaled, rotated, and translated using the composite transform calculated for that character.

How these transforms are applied to each character is, of course, dependent on the particular platform in which the algorithm is implemented. In the Microsoft Windows Presentation Foundation, for example, each character on the page is displayed with either a TextBlock object or a Glyphs object, and the position of the character on the untransformed page is indicated by a coordinate point. In either case, a TransformGroup is set to the RenderTransform property of the TextBlock or Glyphs object. To the Children property of the TransformGroup are added objects of type ScaleTransform, RotateTransform, and TranslateTransform, in that order. The ScaleX and ScaleY properties of the ScaleTransform are set for horizontal and vertical scaling as calculated above. The Angle property of the RotateTransform is set for rotation. The X and Y properties of the TranslateTransform are set for horizontal and vertical translation. When the character is rendered, these transforms cause the character to be scaled, rotated, and moved relative to its original position on the page.

While the invention has been described with reference to several embodiments, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. In this application all units are in the system indicated and all amounts and percentages are by weight, unless otherwise expressly indicated. Also, all citations referred herein are expressly incorporated herein by reference.

I claim:

1. A method wherein the contents of an originating textual electronic document page is mapped onto a simulated undulating topology, as if viewed at a perspective, and then displayed on a screen.

2. The method of claim 1, wherein said undulating topology, as if viewed at a perspective, includes a background image also viewed at a perspective and appearing to be similarly undulated.

3. The method of claim 2, wherein the background is colored in a light blue or pastel.

4. The method of claim 2, wherein the background image contains spectral highlights, as if the display screen is being illuminated from a selected angle.

5. The method of claims 1, wherein the undulating topology and perspective simulate the reading of a book or paper page.

6. The method of claim 1, wherein a sequence of said screens are viewed to simulate the reading of a multi-page document or book.

7. The method of claim 6, wherein the screen sequence alternates simulations of left and right side page undulations possibly including left and right side perspective.

8. The method of claim 1, wherein the display is on a screen having more than 800,000 pixels.

9. The method of claim 1, wherein the screen is in portrait configuration and is thereby taller than it is wide.

10. The method of claim 1, wherein each screen displayed page of a sequence of pages may be altered by one of being mapped onto a differing topology, viewed, as if from a differing perspective, or having a different background.

11. The method of claims 2, wherein the undulating topology and perspective simulate the reading of a book or paper page.

12. The method of claim 2, wherein a sequence of said screens are viewed to simulate the reading of a multi-page document or book.

13. The method of claim 2, wherein the display is on a screen having more than 800,000 pixels.

14. The method of 2, wherein the screen is in portrait configuration and is thereby taller than it is wide.

15. The method of claim 2, wherein each screen displayed page of a sequence of pages may be altered by one of being mapped onto a differing topology, viewed, as if from a differing perspective, or having a different background.

16. The method of claim 1, wherein the mapping is accomplished by the steps of:
(a) selecting an array of points in the essentially rectilinear originating document;
(b) associating with each of said array points information which indicates the translation, sizing and rotation of a character at the array point location if it were translated onto a selected undulating, perspective viewed surface;
(c) for individual characters in the originating document, utilizing the data of proximate array points to interpolate the appropriate translation, sizing, and rotation values appropriate for that character;
(d) mapping said character onto the display screen using said interpolated translation, sizing and rotation values of that character; and
(e) repeating the steps for each character to be displayed for reading.

17. The method of claim 1, wherein the character mapping is created using one or more of affine transforms, curves defined by parametric formulas, interpolation, and scaling, where each character of text is scaled, rotated, and translated using the composite transform calculated for that character and then rendered using application tools.

18. The method of claim 1, implemented in a computer application wherein a person viewing documents may select a presentation style other than conventional rectilinear display.

19. The method of claim 18, wherein the presentation varies between pages to avoid reader fatigue.
